(19) United States
(12) Patent Application Publication
(10) Pub. No.: US 2014/0053272 A1
(43) Pub. Date: Feb. 20, 2014

(54) Multilevel Introspection of Nested Virtual Machines

(71) Applicants: Sandor LUKACS, Floresti (RO); Dan H. LUTAS, Cluj-Napoca (RO); Raul V. TOSA, Cluj-Napoca (RO)

(72) Inventors: Sandor LUKACS, Floresti (RO); Dan H. LUTAS, Cluj-Napoca (RO); Raul V. TOSA, Cluj-Napoca (RO)

(21) Appl. No.: 13/590,098

(22) Filed: Aug. 20, 2012

(51) Int. Cl. G06F 21/00; G06F 9/455

(52) U.S. Cl. 726/24; 718/1

(57) ABSTRACT

Described systems and methods allow software introspection and/or anti-malware operations in a hardware virtualization system comprising a nested hierarchy of hypervisors and virtual machines, wherein introspection is carried out to any level of the hierarchy from a central location on a host hypervisor. An introspection engine intercepts a processor event occurring in a virtual machine exposed by a nested hypervisor, to determine an address of a software object executing on the respective virtual machine. The address is progressively translated down through all levels of the virtualization hierarchy, to an address within a memory space controlled by the host hypervisor. Anti-malware procedures can thus be performed from the level of the host hypervisor, and may comprise techniques such as signature matching and/or protecting certain areas of memory of the nested virtual machine.

### BACKGROUND

The invention relates to systems and methods for detecting computer malware, and in particular to anti-malware systems using hardware virtualization technology.

Malicious software, also known as malware, affects a great number of computer systems worldwide. In its many forms such as computer viruses, worms, and rootkits, malware presents a serious risk to millions of computer users, making them vulnerable to loss of data and sensitive information, identity theft, and loss of productivity, among others.

Hardware virtualization technology allows the creation of simulated computer environments commonly known as virtual machines, which behave in many ways as physical computer systems. In typical applications such as server consolidation, several virtual machines may run simultaneously on the same hardware platform (physical machine), sharing the hardware resources among them, thus reducing investment and operating costs. Each virtual machine may run its own operating system and/or software applications, separately from other virtual machines. Due to the steady proliferation of malware, each virtual machine operating in such an environment potentially requires malware protection.

There is considerable interest in developing anti-malware solutions for hardware virtualization platforms, solutions which are robust and scalable to any number and/or distribution of virtual machines operating on such platforms.

### SUMMARY

According to one aspect, a physical machine comprises at least a processor configured to operate: a host hypervisor configured to expose a host virtual machine; and a guest hypervisor executing on the host virtual machine and configured to expose a guest virtual machine. The host hypervisor is further configured to: intercept an event comprising accessing a virtual machine configuration area (VMCA) within a memory space of the host virtual machine, the VMCA used by the guest hypervisor to describe the guest virtual machine; in response to intercepting the event, determine, according to a content of the VMCA, a first memory address of a software object executing on the guest virtual machine, the first memory address being located within a memory space of the guest virtual machine; map the first memory address of the software object to a second memory address located within a memory space of the host hypervisor; and determine whether the software object comprises malware according to the second memory address.

According to another aspect, a method comprises employing at least one processor of a physical machine to form a host hypervisor configured to expose a host virtual machine, and a guest hypervisor executing on the host virtual machine and configured to expose a guest virtual machine. The method further comprises employing the at least one processor to intercept an event comprising accessing a virtual machine configuration area (VMCA) within a memory space of the host virtual machine, the VMCA used by the guest hypervisor to describe the guest virtual machine; employing the at least one processor, in response to intercepting the event, to determine, according to a content of the VMCA, a first memory address of a software object executing on the guest virtual machine, the first memory address being located within a memory space of the guest virtual machine; employing the at least one processor to map the first memory address of the software object to a second memory address located within a memory space of the host hypervisor; and employing the at least one processor to determine whether the software object comprises malware according to the second memory address.

According to another aspect, a non-transitory computer-readable medium stores instructions which, when executed, cause a physical machine to form a host hypervisor configured to expose a host virtual machine, and a guest hypervisor executing on the host virtual machine and configured to expose a guest virtual machine. The host hypervisor is further configured to: intercept an event comprising accessing a virtual machine configuration area (VMCA) within a memory space of the host virtual machine, the VMCA used by the guest hypervisor to describe the guest virtual machine; in response to intercepting the event, determine, according to a content of the VMCA, a first memory address of a software object executing on the guest virtual machine, the first memory address being located within a memory space of the guest virtual machine; map the first memory address of the software object to a second memory address within a memory space of the host hypervisor; and determine whether the software object comprises malware according to the second memory address.

According to another aspect, a physical machine comprises at least a processor configured to operate a host hypervisor configured to expose a host virtual machine, and a guest hypervisor executing on the host virtual machine and configured to expose a guest virtual machine. The host hypervisor is further configured to: intercept a privileged instruction of the guest virtual machine, wherein the guest virtual machine does not have processor privilege to execute the privileged instruction; in response to intercepting the privileged instruction, determine a first memory address of a software object according to a parameter of the privileged instruction, the software object executing on the guest virtual machine, wherein the first memory address is located within a memory space of the guest virtual machine; map the first memory address of the software object to a second memory address within a memory space of the host hypervisor; and determine whether the software object comprises malware according to the second memory address.

According to another aspect, a physical machine comprises at least a processor configured to operate a host hypervisor configured to expose a host virtual machine, and a guest hypervisor executing on the host virtual machine and configured to expose a guest virtual machine. The host hypervisor is further configured to: intercept an event comprising transferring control of the processor from the guest virtual machine to the guest hypervisor, to determine a first memory address of a software object within a memory space of the guest virtual machine, the software object executing on the guest virtual machine; in response to intercepting the event, map the first memory address of the software object to a second memory address within a memory space of the host hypervisor; and determine whether the software object comprises malware according to the second memory address.

### BRIEF DESCRIPTION OF THE DRAWINGS

The foregoing aspects and advantages of the present invention will become better understood upon reading the following detailed description and upon reference to the drawings where:

FIG. 1 shows an exemplary anti-malware system protecting a configuration of nested virtual machines operating on a host physical machine, according to some embodiments of the present invention.

FIG. 2 shows an exemplary hardware configuration of a physical machine such as a computer system, according to some embodiments of the present invention.

FIG. 3 illustrates exemplary virtualized hardware components of a virtual machine according to some embodiments of the present invention.

FIG. 4 shows an exemplary mapping of memory addresses in the system configuration of FIG. 1, according to some embodiments of the present invention.

FIG. 5 shows an exemplary sequence of steps carried out by the introspection engine in FIG. 1 according to some embodiments of the present invention.

FIG. 6 shows an exemplary sequence of steps carried out by an embodiment of introspection engine executing on an Intel platform, according to some embodiments of the present invention.

### DETAILED DESCRIPTION OF PREFERRED EMBODIMENTS

In the following description, it is understood that all recited connections between structures can be direct operative connections or indirect operative connections through intermediary structures. A net of elements includes one or more elements. Any recitation of an element is understood to refer to at least one element. A plurality of elements includes at least two elements. Unless otherwise required, any described method steps need not be necessarily performed in a particular illustrated order. A first element (e.g. data) derived from a second element encompasses a first element equal to the second element, as well as a first element generated by processing the second element and optionally other data. Making a determination or decision according to a parameter encompasses making the determination or decision according to the parameter and optionally according to other data. Unless otherwise specified, an indicator of some quantity/data may be the quantity/data itself, or an indicator different from the quantity/data itself. Computer readable media encompass non-transitory media such as magnetic, optic, and semiconductor storage media (e.g. hard drives, optical disks, flash memory, DRAM), as well as communications links such as conductive cables and fiber optic links. According to some embodiments, the present invention provides, inter alia, computer systems comprising hardware (e.g. one or more processors) programmed to perform the methods described herein, as well as computer-readable media encoding instructions to perform the methods described herein.

The following description illustrates embodiments of the invention by way of example and not necessarily by way of limitation.

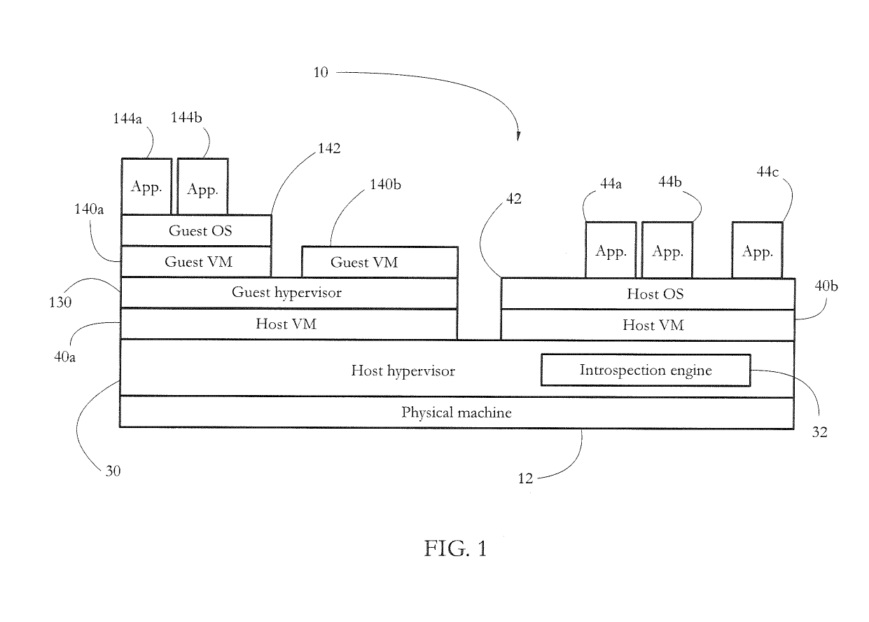

FIG. 1 shows an exemplary anti-malware (AM) system 10 according to some embodiments of the present invention. AM system 10 includes a physical machine 12 such as a computer system running a hardware virtualization platform. A host hypervisor (HV) 30, also known in the art as a virtual machine monitor, comprises software allowing the multiplexing (sharing) by multiple virtual machines of computational resources of physical machine 12, such as processor operations, memory, storage, input/output, and networking devices. In some embodiments, host hypervisor 30 enables multiple virtual machines (VM) and/or operating systems (OS) to run concurrently on physical machine 12, with various degrees of isolation. Examples of popular hypervisors include the VMware ESX™ from VMware Inc. and the open-source Xen hypervisor, among others.

AM system 10 further comprises a set of host virtual machines 40a-b operating concurrently on physical machine 12 and exposed by host hypervisor 30. Virtual machines are commonly known in the art as software emulations of actual physical machines/computer systems, each capable of running its own operating system and software independently of other VMs. While FIG. 1 shows just two host VMs for simplicity, system 10 may include larger numbers (e.g. tens or hundreds) of host VMs 40a-b.

In the exemplary configuration of FIG. 1, host VM 40b runs a host operating system 42, while host VM 40a runs a guest hypervisor 130, which in turn exposes a set of guest virtual machines 140a-b. System 10 may include many levels of nested virtual machine/hypervisor combinations such as the one illustrated in FIG. 1. For instance, another hypervisor may operate on guest VM 140b, exposing yet another layer of virtual machines, etc. The number of VMs 40a-b, 140a-b running on physical machine 12 may vary during the operation of physical machine 12. For example, hypervisors 30, 130 may dynamically launch and/or remove virtual machines to meet demands for processor power or memory, a process known as load balancing. Demand for creation/removal of VMs may be automatic or user-driven. For instance, in a computer paradigm commonly known as infrastructure-as-a-service (IAAS), a user may request to remotely access a computer resource; the respective resource may be created on demand in the form of a virtual machine having the requested parameters.

Guest VM 140a runs a guest operating system (OS) 142. Each OS 42, 142 comprises software that provides an interface to the (virtualized) hardware of its respective VM, and acts as a host for computing applications running on the respective OS. Examples of operating systems 42, 142 include Microsoft Windows®, Mac OS®, Linux, IOS® and Android, among others. Each VM of system 10 may run a plurality of applications (e.g. computer programs) 44a-c, 144a-b, concurrently and independently of other VMs in the system. Such applications include web server, database, word and/or image processing applications, and anti-malware applications, among others.

In some embodiments, an introspection engine 32 executes substantially at the same privilege level as host hypervisor 30, and is configured to perform introspection of virtual machines exposed by hypervisor 30 and/or introspection of nested virtual machines such as guest VMs 140a-b, up to any level of nesting, as shown below. For instance, engine 32 may be a component of host hypervisor 30. In some embodiments, introspection of a VM comprises analyzing a behavior of a software object executing on the respective VM, determining and/or accessing memory addresses of such software objects, and analyzing a content of memory located at such addresses, among others. An exemplary introspection operation comprises determining whether the respective software object is malicious, e.g., whether it comprises malware such as a computer virus. In some embodiments, software objects analyzed by introspection engine 32 comprise processes, instruction streams, data structures, as well as driver components and parts of the operating system executing on the respective VM, among others.

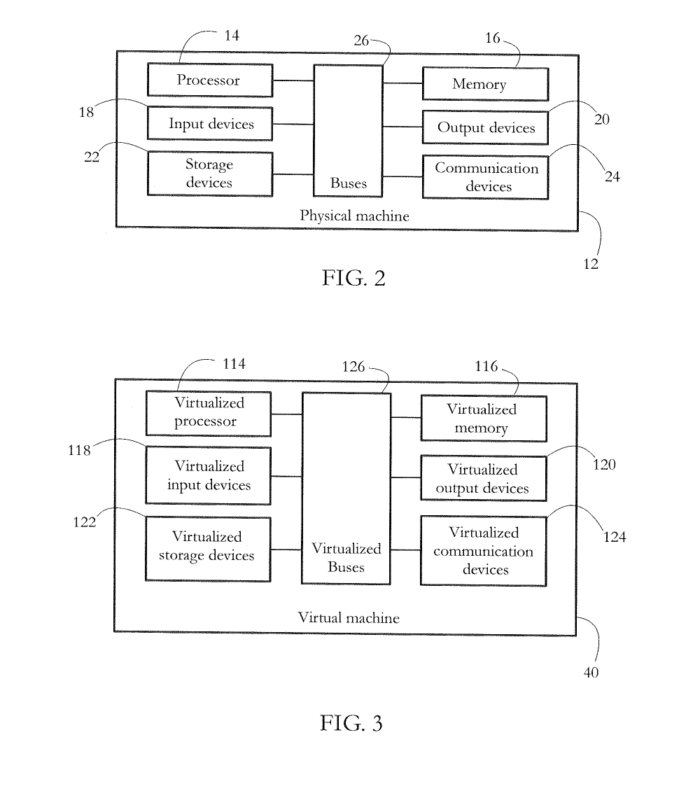

Software instructions implementing AM system 10 are executed by physical machine 12 (FIG. 2). In some embodiments, physical machine 12 is a computer system comprising a processor 14, a memory unit 16, a set of input devices 18, a set of output devices 20, a set of storage devices 22, and a set of communication devices 24, all connected by a set of buses 26.

In some embodiments, processor 14, also known as a central processing unit (CPU), comprises a physical device, such as a multi-core integrated circuit, configured to execute computational and/or logical operations with a set of signals and/or data. In some embodiments, such logical operations are delivered to processor 14 in the form of a sequence of instructions, for instance machine code or other type of software. Memory unit 16 may comprise volatile computer-readable media (e.g. RAM) storing data/signals accessed or generated by processor 14 in the course of carrying out instructions. In some embodiments, memory unit 16 is configured as a plurality of storage containers, each container labeled by a unique memory address. Input devices 18 may include computer keyboards and mice, among others, allowing a user to introduce data and/or instructions into physical machine 12. Output devices 20 may include display devices such as monitors. Storage devices 22 include computer-readable media enabling the non-volatile storage, reading, and writing of software instructions and/or data. Exemplary storage devices 22 include magnetic and optical disks and flash memory devices, as well as removable media such as CD and/or DVD disks and drives. Communication devices 24 enable physical machine 12 to connect to a computer network and/or to other physical machines/computer systems. Typical communication devices 24 include network adapters. Buses 26 collectively represent the plurality of system, peripheral, and chipset buses, and/or all other circuitry enabling the inter-communication of devices 14-24 of physical machine 12. For example, buses 26 may comprise the northbridge connecting processor 14 to memory 16, and/or the southbridge connecting processor 14 to devices 18-24, among others.

In some embodiments, software forming part of hypervisors 30, 130 creates a plurality of virtualized (software-emulated) devices corresponding to each physical device 14-26, and assigns a set of virtual devices to each VM operating on physical machine 12. Thus, each VM operates as if it possesses its own set of physical devices 14-26, i.e., as a complete computer system. FIG. 3 illustrates an exemplary VM configuration, comprising a virtualized processor 114, a virtualized memory unit 116, virtualized input 118, output 120, storage 122, and communication devices 124. In some embodiments, only a subset of physical devices 14-26 is virtualized.

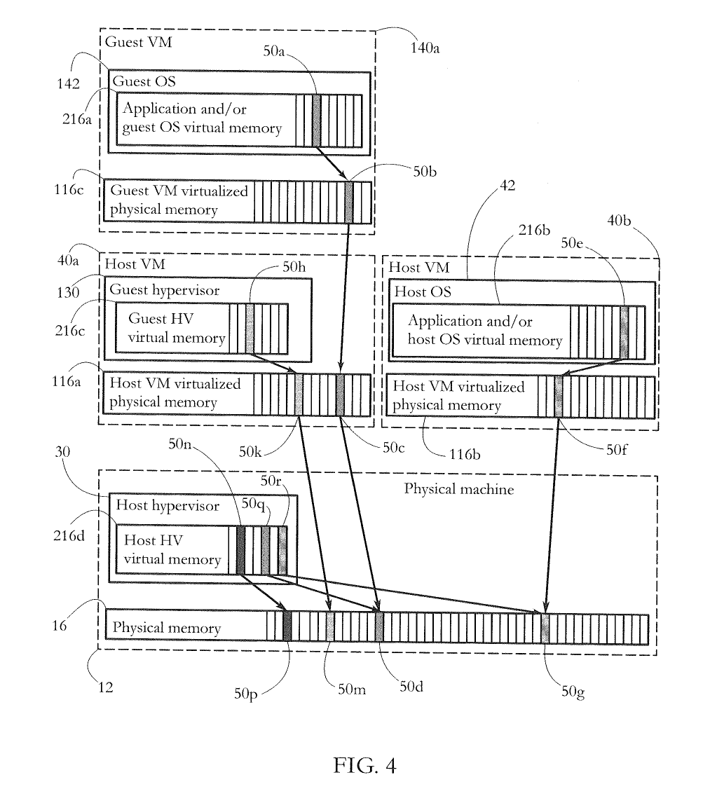

FIG. 4 shows an exemplary mapping of memory addresses in the system configuration of FIG. 1, according to some embodiments of the present invention. Host hypervisor 30 manages the operation of host VMs 40a-b, including presenting each machine 40a-b with its own virtualized physical memory space 116a-b, respectively. Similarly, guest hypervisor 130 presents guest VM 140a with its own virtualized physical memory space 116c. In some embodiments, address mapping between virtual machines and the underlying physical machine is achieved using shadow page tables maintained by hypervisors 30 and/or 130, a technique well known in the field of virtualization. On an Intel platform with virtual machine extensions, hypervisor 30 may use the Extended Page Tables (EPT) capability of processor 14 to translate between virtualized physical memory addresses of VMs 40a-b and actual physical addresses on machine 12. When machine 12 comprises a processor from Advanced Micro Devices (AMD), Inc., host HV 30 may employ Nested Page Tables (NPT) to translate between virtualized physical memory addresses and actual physical memory addresses on machine 12. Similarly, guest HV 130 may use EPT or NPT to perform address translation between virtualized physical memory space 116c of guest VM 140a and virtualized physical memory space 116a of host VM 40a.

In the example of FIG. 4, a software object such as application 144a or a part of guest OS 142 is assigned a virtual address space 216a (also termed logical address space) by guest OS 142. When the software object attempts to access an exemplary memory address 50a, address 50a is translated by the virtualized processor of guest VM 140a, based on translation tables configured and controlled by guest OS 142, into an address 50b within the virtualized physical memory space 116c of virtual machine 140a. Address 50b is also known in the art as a guest-physical address. Guest HV 130, which configures and controls memory space 116c, then maps (for instance using shadow page tables, EPT, or NPT means as discussed above) address 50b to an address 50c within the virtualized physical memory space 116a of host VM 40a. Guest HV 130 also sets up its own virtual memory space 216c within host VM 40, mapping an exemplary address 50h to an address 50k in virtualized physical memory space 116a. Host hypervisor 30 then maps addresses 50c and 50k to addresses 50d and 50m, respectively, within physical memory space 16 of physical machine 12.

Host HV 30 sets up its own virtual memory space 216d comprising a representation of physical memory 16, and employs a translation mechanism (for instance, page tables) to map addresses in space 216d into actual addresses in physical memory 16. In FIG. 4, such an exemplary mapping translates an address 50m into an address 50p. In another exemplary mapping, physical address 50d corresponding to a software object executing in guest VM 140a, as shown above, may be mapped by host HV 30 to address 50q within memory space 216d of host HV 30.

Similarly, a virtual memory space 216b is set up by host OS 42 for applications (e.g. 44c) or other software objects executing on host VM 40b. An exemplary virtual address 50e within space 216b is translated by the virtualized processor of host VM 40b, based on translation tables configured and controlled by host OS 42, into and address 50f within a virtualized physical memory space 116b of host VM 40b. Address 50f is further mapped by host HV 30 into an address 50g within physical memory space 16. In some embodiments, translation from memory spaces 116a-b to physical memory space 16 may employ extended page tables (EPT) or nested page tables (NPT) maintained by host HV 30. In some embodiments, address 50g has a corresponding internal representation 50r within virtual memory space of host HV 30.

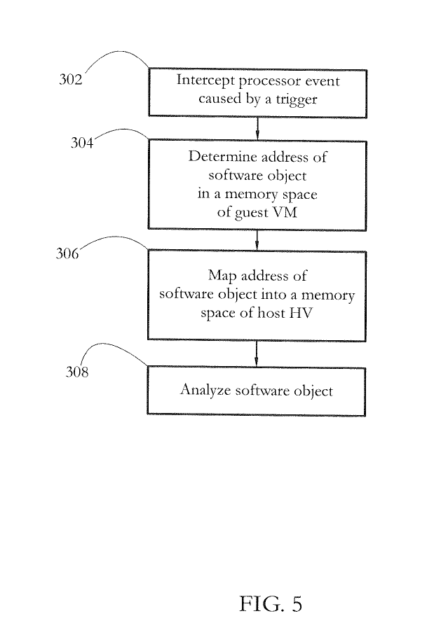

FIG. 5 shows an exemplary sequence of steps performed by introspection engine 32 according to some embodiments of the present invention. In some embodiments, engine 32 determines a set of properties, such as a memory address, of a software object executing on guest VM 140a-b.

In a step 302, introspection engine 32 intercepts a processor event occurring as a result of an introspection trigger. An exemplary introspection trigger comprises a temporal trigger, such as meeting a time condition. For instance, engine 32 may perform introspection of a virtual machine according to a time schedule, e.g., every 5 minutes. Another exemplary trigger may comprise the respective VM launching at least one of a group of selected processes, or determining that a predetermined time interval, e.g. 5 seconds, has elapsed since the launch of such a process on the respective VM. Other exemplary triggers include a fault or another type of interrupt, a page table violation, and accessing a protected memory region of the respective VM, among others.

The processor event intercepted in step 302 may comprise a virtual machine exit event. In some embodiments, virtual machine exit events comprise transferring control of the processor from a virtual machine to the hypervisor exposing the respective VM (for instance, from guest VM 140a to guest hypervisor 130 or to host hypervisor 30 in FIG. 1). An exemplary virtual machine exit event includes the VMexit process on Intel® platforms.

Several exemplary techniques for intercepting processor events exist in the art; some are commonly known under the name “trap and emulate” and are employed in the operation of hypervisors and virtual machines. For instance, in step 302, engine 32 may intercept a privileged instruction issued by the software object and/or guest hypervisor 130. In some embodiments, a privileged instruction comprises a processor instruction requiring special processor privileges to be carried out. Exemplary privileged instructions include storage protection setting, interrupt handling, timer control, input/output, and special processor status-setting instructions, among others. In some embodiments, privileged instructions can only be executed in root operation mode, such as VMX root on Intel® platforms.

In some embodiments, when issued from within a virtual machine such as guest VM 140a-b, a privileged instruction may trigger a virtual machine exit event, resulting in transferring control of the processor to the hypervisor controlling the respective VM (e.g., guest hypervisor 130), or directly to host hypervisor 30. Introspection engine 32 operates at the same privilege level as host hypervisor 30 and therefore can intercept such privileged instructions and/or VM exit events. Step 302 may also comprise intercepting an instruction transferring control of the processor from guest HV 130 (or host NV 30) to the virtual machine executing the software object. Examples of such instructions include VMResume and VMLaunch on Intel platforms, and VMRun on AMD platforms.

In a step 304, engine 32 determines an address of the target software object within a memory space of the guest virtual machine executing the software object (for instance, address 50b in FIG. 4). In some embodiments, engine 32 may determine such addresses according to a parameter of the instruction intercepted in step 302, for instance according to a pointer of the guest virtual machine transferring control of the processor to guest HV 130.

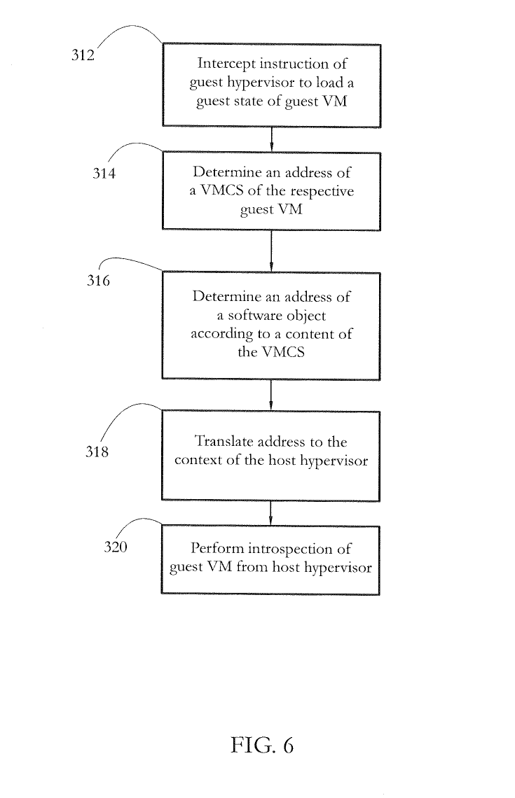

In some embodiments, processor 14 is configured to store and access data describing virtual machines to/from a virtual machine configuration area (VMCA) of memory. The VMCA may comprise a dedicated region within the memory space of guest HV 130, storing data used to describe each VM executing on HV 130, and/or the respective VM's CPU state. In embodiments using Intel VT®-enabled processors, the VMCA is named Virtual Machine Control Structure (VMCS), while in embodiments using AMD-V®-enabled processors, it is known as a Virtual Machine Control Block (VMCB). In some embodiments, the address determination of step 304 is performed according to a content of a VMCA of the virtual machine executing the target software object. An example of such determination is discussed below, in relation to FIG. 6.

In a step 306 (FIG. 5), introspection engine 32 translates the address determined in step 304 into an address within a memory space of host HV 30, such as virtual space 216d in FIG. 4. As part of step 306, some embodiments of engine 32 translate the address determined in step 304 to an address within a memory space of the host VM executing guest hypervisor 130 (e.g., host VM 40a in FIG. 1). For instance, memory translation from guest VM 140a to host VM 40a may proceed according to nested/extended page tables maintained by guest HV 130 (see e.g., translating address 50b to 50c in FIG. 4). Such guest-to-host VM address mapping may be extended iteratively to any level of the virtualization hierarchy.

Engine 32 may then translate the address from the memory space of the host VM to an address within a memory space of host HV 30 (e.g., mapping address 50c to 50d in FIG. 4). In some embodiments, such memory translation may further employ nested/extended page tables maintained by host HV 30, and/or host HV 30's own representation of physical memory space 16 (e.g., interpreting address 50d as address 50q in FIG. 4).

In a step 308, introspection engine 32 analyzes the target software object, for instance to determine whether the software object comprises malware. Step 308 may employ any malware-detecting method known in the art. Such methods commonly include behavior-based techniques and content-based techniques. In content-based methods, a pattern-matching algorithm may be used to compare the contents of a section of memory identified substantially at the address determined in step 306 (for example, a section of memory starting at said address) to a collection of known malware-identifying signatures. If a known malware signature is found in the respective section of memory, the respective software object may be labeled as malicious. Behavior-based methods comprise monitoring the execution of the target software object to identify malicious behavior, and blocking the respective malicious behavior.

In some embodiments, analyzing the software object (step 308) may comprise preventing the target software object from modifying certain protected memory regions. In the example of FIG. 1, since guest HV 130 has control over the memory space of the guest VM 140a, protecting certain regions of memory of OS 142 may be achieved e.g. by HV 130 setting appropriate access rights to the respective memory regions. In some embodiments, such access rights may be set by host HV 30. When guest OS 142 is a Linux operating system, exemplary protected memory regions include: the kernel (read-only code and/or data such as sys_call_table), sysenter/syscall control registers, addresses int 0x80 (syscall) and/or int 0x01, among others. Exemplary protected regions on a Windows guest OS 142 include: the kernel (read-only code and/or data, including the System Service Dispatch Table), various descriptor tables (e.g., interrupt, general and/or local), sysenter/syscall control registers and/or other registers such as an interrupt descriptor table register (IDTR), a global descriptor table register (GDTR), and a local descriptor table register (LDTR). In some embodiments, protected regions may also comprise specific driver objects and fast I/O dispatch tables (e.g., disk, atapi, clfs, fltmgr, ntfs, fastfat, iastor, iastorv), among others. Other protected regions may include certain model specific registers (MSRs), such as ia32_systenter_eip, ia32_sysenter_esp, ia32_efer, ia32_star, ia32_{—}1star, and ia32_gs_base. In some embodiments, introspection engine 32 also protects page tables, to prevent unauthorized rerouting to addresses housing malicious code.

FIG. 6 shows an exemplary sequence of steps performed by introspection engine 32 on an Intel platform, i.e., in an embodiment of physical machine 12 carrying a processor from Intel, Inc. In such embodiments, guest HV 130 may maintain a special data structure known as a virtual machine control structure (VMCS) to describe guest VMs set up by HV 130. The format of the VMCS may be implementation-specific. There may be a distinct VMCS for each guest VM 140a-b configured to execute on host VM 40a. When VMs 140a-b comprise multiple virtualized processors 114 (see, e.g., FIG. 3), HV 130 may maintain a distinct VMCS for each virtual processor. In some embodiments, each VMCS may comprise a guest state area and a host state area, the guest state area storing data such as CPU state and/or control registers of the respective VM, and the host state area storing similar data of HV 130. In some embodiments, each processor associates a region in memory with each VMCS, named VMCS region. Software may reference a specific VMCS using an address of the region, such as a VMCS pointer, within the memory space of host VM 40a.

In some embodiments, the processor may maintain the state of an active VMCS in memory, on the processor, or both. At any given time, at most one VMCS may be loaded on the processor, representing the virtual machine 140a-b currently having control of the processor. When control of the processor is transferred from a VM to the hypervisor (a process termed VMExit on Intel platforms), the processor saves the state of the VM to the guest state area of the VMCS of the respective virtual machine. To switch context from HV operation to VM operation, HV 130 may issue an instruction to load the guest state of the respective VM onto the processor by accessing the contents of the respective VMCS, an operation known in the art as a guest state loading instruction. Examples of such instructions are VMLaunch and VMResume on Intel platforms, and VMRun on AMD platforms. In some embodiments, guest state loading instructions are privileged instructions, requiring hypervisor root privilege such as VMX root mode on Intel platforms.

In a step 312 (FIG. 6), introspection engine 32 may intercept a guest state loading instruction issued by guest HV 130. Being a privileged instruction, the guest state loading instruction transfers control of the processor to host HV 30 and therefore is accessible to engine 32 operating in the context of HV 30. In one example, the guest state loading instruction represents the launch of a new guest VM controlled by guest HV 130. In another example, the guest state loading instruction may be triggered when a software object executing in an already running guest VM attempts to execute a privileged instruction (see above, in relation to FIG. 5). The respective privileged instruction triggers a virtual machine exit event and the processor switches from the context of the guest VM to the context of host HV 30. To resume operation of the respective VM, guest HV 130 may then issue an instruction to re-load the VMCS of the respective guest VM. Re-loading the VMCS of the guest VM may trigger a VMexit event transferring control of the processor to host HV 30. Host HV 30 then executes the re-load instruction, switching back to the context of the respective guest VM. In some embodiments, in step 312 introspection engine 32 may employ the VMExit handler of guest HV 130 or host HV 30. On Intel-VT® enabled platforms, the VMExit event handler can determine the cause for the context switch (e.g., a VMLaunch, VMResume, or VMPtrld instruction).

In a step 314, introspection engine 32 determines an address of the guest state area to be loaded according to the instruction intercepted in step 312. Such addresses may be stored in memory as VMCS pointers. An exemplary instruction to load a VMCS pointer on an Intel platform is the VMPtrld instruction, so step 312 may comprise intercepting such an instruction issued by guest HV 130. In some embodiments, a guest state loading instruction such as VMResume may have no parameters at the moment of invocation. In such a case, engine 32 may save a memory parameter of the latest VMPtrld instruction intercepted for the respective guest VM, and determine the address of the guest state area according to the memory parameter.

In a step 316, engine 32 may determine an address of a software object executing on the respective guest VM, according to a content of the VMCS. In some embodiments, engine 32 may access the VMCS according to the address determined in step 314. The content may include a content of a control register of the guest VM currently being loaded and a value of a pointer into a virtualized physical memory space of the respective guest VM (e.g., item 116c in FIG. 4), among others. In some embodiments, the content may comprise an address of a page table used by the respective guest VM for memory translations (e.g. to map address 50a to 50b in FIG. 4), and an address of a software object executing on the respective guest VM 140a-b (e.g., items 50a and/or 50b in FIG. 4), among others.

In an example of address determination, the VMCS may comprise data structures such as a plurality of critical registers controlling the operation of a guest virtual machine. Such registers are stored and/or loaded every time control of the processor is transferred to or from the respective virtual machine. For example, the VMCS may include a register storing an address of the kernel mode system service handler (e.g., sysenter). The VMCS may also store model-specific registers such as ia32_gs_base. Such registers point to addresses of specific structures and/or software objects within the memory space of the operating system executing on the respective VM (e.g., address space 216a or 116c in FIG. 4).

In a step 318, engine 32 may translate the address determined in step 316 to the context of host HV 30. Contents of the VMCS of guest VM 140a-b determined in step 316, such as pointers and/or registers, reference addresses within the virtual memory of the respective guest OS, and/or addresses within the virtualized physical memory of the respective guest VM (e.g., address space 116c in FIG. 4), so in order to be accessible from within host HV 30, such addresses need to be remapped into a memory space of host HV 30. In some embodiments, memory translation from guest VM 140a to host VM 40a may employ nested/extended page tables maintained by guest HV 130, while translations from host VM 40a to the context of host HV 30 may employ nested/extended page tables maintained by HV 30 and host HV 30's own representation of physical memory space 16, as described above.

In a step 320, engine 32 performs introspection of the respective guest VM 140a-b. In some embodiments, introspection comprises identifying internal data structures of guest OS 142, such as objects within the kernel space and driver objects, among others. Introspection may further comprise determining whether the identified kernel objects and/or data structures are malicious, and/or whether software objects executing on guest OS 142 comprise malware. In some embodiments, when malware is detected, step 320 may further comprise issuing a notification to a user and/or blocking the malicious behavior of the respective process.

The exemplary systems and methods described above allow malware detection and/or software introspection operations in a hardware virtualization system comprising a nested hierarchy of hypervisors and virtual machines, wherein introspection is carried out to all levels of the hierarchy from a central location on a host hypervisor.

Developments in hardware virtualization technology allow applications such as server farms, in which hundreds of virtual machines run concurrently on the same physical machine, thus greatly reducing hardware investment and operating costs. Due to the steady proliferation of malware agents such as computer viruses, worms, and rootkits, each virtual machine operating in such an environment potentially requires malware protection.

Conventional malware scanning methods are relatively computationally intensive and require an effort in maintaining and updating large databases of malware-related data such as malware-identifying signatures. In some embodiments described above, a single introspection engine may take on the computational load of malware detection, thus removing some of the scanning burden from guest virtual machines and potentially reducing the number of virtual CPU cycles used for malware detection. Also, by removing the scanning engines and malware databases from each client, some embodiments of the present invention remove a considerable storage redundancy and avoid the delivery of data-heavy software updates to a large number of virtual machines on a regular basis. The storage, CPU, and bandwidth efficiency gains may come at the expense of additional latency introduced by multilayer memory mapping between the introspection engine and guest VMs. To further alleviate the CPU load, instead of performing introspection in real time, introspection of guest VMs may be carried out according to a time schedule (e.g., once every few minutes), or at predetermined time intervals following the launch of certain target processes on the respective VM.

In one potential approach, malware scanning could be performed statically, during downtime or maintenance, by an application running outside the respective VM and capable of inspecting a snapshot of the entire memory contents of the VM. By contrast, some embodiments of the present invention operate an introspection/anti-malware engine with no downtime or freeze for the respective guest VM. The processes running on the guest virtual machine need not be blocked/frozen by the introspection routines. Instead, some embodiments of the present invention exploit events such as transferring control of the processor from a guest VM to a hypervisor, events which already occur in the normal operation of a hardware virtualization platform, to additionally perform introspection of the respective guest VM.

Some conventional anti-malware methods employ an anti-malware agent executing inside a target virtual machine, to gather information about the respective VM. Such configurations are vulnerable to malware operating within the same VM, which can interfere with the operations of the anti-malware agent; such malware has substantially the same processor privilege level as the anti-malware agent and can therefore subvert it. By contrast, in at least some embodiments of the present invention, the anti-malware agent (introspection engine) operates outside the target VM, sometimes many layers of virtualization away. Such an introspection engine may not be subverted by malware executing inside the target VM, since the engine may be configured to operate at a processor privilege level substantially closer to root mode than the respective malware. Processes executing inside a VM may have no indication that they are being monitored by a process executing in an underlying hypervisor.

For simplicity, FIGS. 1 and 4 show a system configuration comprising only one level of nested hypervisors (a guest HV operating inside a host HV), but the methods and systems of the present invention are in no way limited to a one-level nested hierarchy of virtual machines. For instance, referring to FIG. 1, another guest hypervisor may operate within guest VM 140a, exposing its own set of guest virtual machines, etc. The operation of introspection engine 32 described above in relation to FIGS. 5 and 6 may be extended to such a configuration by e.g, extending the address translation steps 306 and/or 318 (FIGS. 5 and 6) to cover each pair of hypervisors in the nested hierarchy.

Emerging technologies and services such as distributed computing and infrastructure-as-a-service often require that hardware virtualization platforms be flexible and capable of dynamically changing the architecture of hypervisors/virtual machines executing on such platforms. Some embodiments of the present invention are insensitive to the details of the hypervisor/virtual machine hierarchy (see FIG. 1); the same introspection engine may monitor a broad variety of architectures, including a dynamically changing configuration.

It will be clear to one skilled in the art that the above embodiments may be altered in many ways without departing from the scope of the invention. Accordingly, the scope of the invention should be determined by the following claims and their legal equivalents.

What is claimed is:

1. A physical machine comprising at least a processor configured to operate:
a host hypervisor configured to expose a host virtual machine; and
a guest hypervisor executing on the host virtual machine and configured to expose a guest virtual machine; wherein
the host hypervisor is further configured to:
intercept an event comprising accessing a virtual machine configuration area (VMCA) within a memory space of the host virtual machine, the VMCA used by the guest hypervisor to describe the guest virtual machine;
in response to intercepting the event, determine, according to a content of the VMCA, a first memory address of a software object executing on the guest virtual machine, the first memory address being located within a memory space of the guest virtual machine;
map the first memory address of the software object to a second memory address located within a memory space of the host hypervisor; and
determine whether the software object comprises malware according to the second memory address.

2. The physical machine of claim wherein the host hypervisor is further configured to intercept the event in response to determining whether a time condition is satisfied.

3. The physical machine of claim 2, wherein determining whether the time condition is satisfied comprises determining a time elapsed since a launch of a selected process by the guest virtual machine.

4. The physical machine of claim 1, wherein determining whether the software object comprises malware includes determining whether a section of memory identified by the second memory address comprises a malware-indicative signature.

5. The physical machine of claim 1, wherein determining whether the software object comprises malware includes detecting an attempt by the software object to modify a content of a protected region of the memory space of the guest virtual machine.

6. The physical machine of claim 5, wherein determining whether the software object comprises malware further includes preventing the software object from modifying the content of the protected region.

7. The physical machine of claim 5, wherein the content of the protected region includes a page table of the guest virtual machine.

8. The physical machine of claim 5, wherein the protected region belongs to a memory region occupied by the kernel of a guest operating system executing on the guest virtual machine.

9. The physical machine of claim 5, wherein the protected region comprises a part of a driver object of a guest operating system executing on the guest virtual machine.

10. The physical machine of claim 1, wherein the event comprises transferring control of the processor from the guest virtual machine to the host hypervisor.

11. The physical machine of claim 1, wherein the event comprises transferring control of the processor from the host hypervisor to the guest virtual machine.

12. The physical machine of claim 1, wherein the event includes a virtual machine launch instruction.

13. The physical machine of claim 1, wherein the event includes an instruction to load a pointer to the VMCA.

14. A method comprising:
employing at least one processor of a physical machine to form:
a host hypervisor configured to expose a host virtual machine; and
a guest hypervisor executing on the host virtual machine and configured to expose a guest virtual machine;
employing the at least one processor to intercept an event comprising accessing a virtual machine configuration area (VMCA) within a memory space of the host virtual machine, the VMCA used by the guest hypervisor to describe the guest virtual machine;
employing the at least one processor, in response to intercepting the event, to determine, according to a content of the VMCA, a first memory address of a software object executing on the guest virtual machine, the first memory address being located within a memory space of the guest virtual machine;
employing the at least one processor to map the first memory address of the software object to a second memory address located within a memory space of the host hypervisor; and
employing the at least one processor to determine whether the software object comprises malware according to the second memory address.

15. The method of claim 14, further comprising intercepting the event in response to determining whether a time condition is satisfied.

16. The method of claim 15, wherein determining whether the time condition is satisfied comprises determining a time elapsed since a launch of a selected process by the guest virtual machine.

17. The method of claim 14, wherein determining whether the software object comprises malware includes determining whether a section of memory identified by the second memory address comprises a malware-indicative signature.

18. The method of claim 14, wherein determining whether the software object comprises malware includes detecting an attempt by the software object to modify a content of the protected region of the memory space of the guest virtual machine.

19. The method of claim 18, wherein determining whether the software object comprises malware further includes preventing the software object from modifying the content of the protected region.

20. The method of claim 18, wherein the content of the protected region includes a page table of the guest virtual machine.

21. The method of claim 18, wherein the protected region belongs to a memory region occupied by the kernel a guest operating system executing on the guest virtual machine.

22. The method of claim 18, wherein the protected region comprises a part of a driver object of a guest operating system executing on the guest virtual machine.

23. The method of claim 14, wherein the event comprises transferring control of the processor from the guest virtual machine to the host hypervisor.

24. The method of claim 14, wherein the event comprises transferring control of the processor from the host hypervisor to the guest virtual machine.

25. The method of claim 14, wherein the event includes a virtual machine launch instruction.

26. The method of claim 14, wherein the event includes an instruction to load a pointer to the VMCA.

27. A non-transitory computer-readable medium storing instructions which, when executed, cause a physical machine to form:
a host hypervisor configured to expose a host virtual machine; and
a guest hypervisor executing on the host virtual machine and configured to expose a guest virtual machine; wherein
the host hypervisor is further configured to:
intercept an event comprising accessing a virtual machine configuration area (VMCA) within a memory space of the host virtual machine, the VMCA used by the guest hypervisor to describe the guest virtual machine;
in response to intercepting the event, determine, according to a content of the VMCA, a first memory address of a software object executing on the guest virtual machine, the first memory address being located within a memory space of the guest virtual machine;
map the first memory address of the software object to a second memory address within a memory space of the host hypervisor; and
determine whether the software object comprises malware according to the second memory address.

28. The computer-readable medium of claim 27, wherein the host hypervisor is further configured to intercept the event in response to determining whether a time condition is satisfied.

29. The computer-readable medium of claim 28, wherein determining whether the time condition is satisfied comprises determining a time elapsed since a launch of a selected process by the guest virtual machine.

30. A physical machine comprising at least a processor configured to operate:
a host hypervisor configured to expose a host virtual machine; and
a guest hypervisor executing on the host virtual machine and configured to expose a guest virtual machine; wherein
the host hypervisor is further configured to:
intercept a privileged instruction of the guest virtual machine, wherein the guest virtual machine does not have processor privilege to execute the privileged instruction;
in response to intercepting the privileged instruction, determine a first memory address of a software object according to a parameter of the privileged instruction, the software object executing on the guest virtual machine, wherein the first memory address is located within a memory space of the guest virtual machine;
map the first memory address of the software object to a second memory address within a memory space of the host hypervisor; and
determine whether the software object comprises malware according to the second memory address.

31. A physical machine comprising at least a processor configured to operate:
a host hypervisor configured to expose a host virtual machine; and
a guest hypervisor executing on the host virtual machine and configured to expose a guest virtual machine; wherein
the host hypervisor is further configured to:
intercept an event comprising transferring control of the processor from the guest virtual machine to the guest hypervisor, to determine a first memory address of a software object within a memory space of the guest virtual machine, the software object executing on the guest virtual machine;
in response to intercepting the event, map the first memory address of the software object to a second memory address within a memory space of the host hypervisor; and
determine whether the software object comprises malware according to the second memory address.
